(19) United States
(12) Patent Application Publication
(10) Pub. No.: US 2015/0261880 A1
(43) Pub. Date: Sep. 17, 2015

(54) TECHNIQUES FOR TRANSLATING USER INTERFACES OF WEB-BASED APPLICATIONS

(71) Applicant: Google Inc., Mountain View, CA (US)

(72) Inventors: Yongping Luo, San Ramon, CA (US); Chenjun Wu, Mountain View, CA (US)

(73) Assignee: GOOGLE INC., Mountain View, CA (US)

(21) Appl. No.: 14/214,760

(22) Filed: Mar. 15, 2014

(51) Int. Cl. G06F 17/30; H04L 29/08

(52) U.S. Cl. CPC G06F 17/30908; H04L 67/10

(57) ABSTRACT

Computer-implemented techniques include receiving, at a request server having one or more processors, a request for a web-based application from a computing device. The techniques include obtaining, at the request server, a natural language associated with the request. The techniques include determining, at the request server, user interface (UI) strings for the web-based application. The techniques include obtaining, at the request server, translations of the UI strings in the natural language to obtain translated UI strings. The techniques also include transmitting, by the request server, the translated UI strings to the computing device, wherein the translated UI strings cause the computing device to execute the web-based application using the translated UI strings.

### FIELD

The present disclosure relates to language translation at computing devices and, more particularly, to techniques for translating user interfaces of web-based applications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A web-based application is a software application that is executable by web browser software executing on a computing device. The web-based application can be coded in a browser-supported programming language, such as JavaScript. The web-based application can also be associated with a browser-rendered markup language, such as hypertext markup language (HTML). A software developer may develop the web-based application in one or more different natural languages. For example, the one or more different natural languages may include English and/or other commonly used natural languages. Users of other natural languages, however, may be unable to utilize the web-based application unless text strings of its user interface are translated to their natural language.

### SUMMARY

A computer-implemented method is presented. The method can include receiving, at a request server having one or more processors, a hypertext markup language (HTML) request for a web-based application from a computing device. The method can include obtaining, at the request server, a natural language from the HTML request. The method can include transmitting, from the request server, the HTML request to an application server associated with the web-based application, the HTML request causing the application server to obtain unique identifiers for user interface (UI) strings of the web-based application. The method can include receiving, at the request server, the unique identifiers for the UI strings from the application server. The method can include transmitting, from the request server, the unique identifiers for the UI strings to a translation server associated with a translation datastore, the unique identifiers causing the translation server to retrieve translations of the UI strings in the natural language from the translation datastore using the unique identifiers to obtain translated UI strings. The method can include receiving, at the request server, the translated UI strings from the translation server. The method can also include transmitting, from the request server, an HTML response including the translated UI strings to the computing device, the translated UI strings causing the computing device to execute the web-based application using the translated UI strings.

Another computer-implemented method is also presented. The method can include receiving, at a request server having one or more processors, a request for a web-based application from a computing device. The method can include obtaining, at the request server, a natural language associated with the request. The method can include determining, at the request server, UI strings for the web-based application. The method can include obtaining, at the request server, translations of the UI strings in the natural language to obtain translated UI strings. The method can also include transmitting, by the request server, the translated UI strings to the computing device, wherein the translated UI strings cause the computing device to execute the web-based application using the translated UI strings.

In some implementations, determining the UI strings for the web-based application further includes: transmitting, from the request server, the request for the web-based application to an application server associated with the web-based application, and receiving, at the request server, unique identifiers for the UI strings for the web-based application from the application server.

In other implementations, obtaining the translated UI strings further includes: transmitting, from the request server, the unique identifiers for the UI strings and the natural language to a translation server associated with a translation datastore, and receiving, at the request server, the translated UI strings from the translation server.

In some implementations, transmitting the unique identifiers for the UI strings and the natural language to the translation server causes the translation server to retrieve the translated UI strings from the translation datastore using the unique identifiers.

In other implementations, the request for the web-based application is an HTML request.

In some implementations, the natural language is obtained from the HTML request.

In other implementations, transmitting the translated UI strings to the computing device includes transmitting, from the request server, an HTML response including the translated UI strings to the computing device.

In some implementations, obtaining the natural language associated with the request further includes determining, at the request server, a preferred natural language of a user associated with the computing device to obtain the natural language.

A request server is also presented. The request server can have one or more processors configured to execute operations including receiving a request for a web-based application from a computing device. The operations can include obtaining a natural language associated with the request. The operations can include determining UI strings for the web-based application. The operations can include obtaining translations of the UI strings in the natural language to obtain translated UI strings. The operations can also include transmitting the translated UI strings to the computing device, wherein the translated UI strings cause the computing device to execute the web-based application using the translated UI strings.

In some implementations, determining the UI strings for the web-based application further includes: transmitting the request for the web-based application to an application server associated with the web-based application, and receiving unique identifiers for the UI strings for the web-based application from the application server.

In other implementations, obtaining the translated UI strings further includes: transmitting the unique identifiers for the UI strings and the natural language to a translation server associated with a translation datastore, and receiving the translated UI strings from the translation server.

In some implementations, transmitting the unique identifiers for the UI strings and the natural language to the translation server causes the translation server to retrieve the translated UI strings from the translation datastore using the unique identifiers.

In other implementations, the request for the web-based application is an HTML request.

In some implementations, the natural language is obtained from the HTML request.

In other implementations, transmitting the translated UI strings to the computing device includes transmitting an HTML response including the translated UI strings to the computing device.

In some implementations, obtaining the natural language associated with the request further includes determining a preferred natural language of a user associated with the computing device to obtain the natural language.

A non-transitory computer-readable medium is also presented. The computer-readable medium can have instructions stored thereon that, when executed by one or more processors of a request server, cause the request server to perform operations including receiving a request for a web-based application from a computing device. The operations can include obtaining a natural language associated with the request. The operations can include determining UI strings for the web-based application. The operations can include obtaining translations of the UI strings in the natural language to obtain translated UI strings. The operations can also include transmitting the translated UI strings to the computing device, wherein the translated UI strings cause the computing device to execute the web-based application using the translated UI strings.

In some implementations, determining the UI strings for the web-based application further includes: transmitting the request for the web-based application to an application server associated with the web-based application, and receiving unique identifiers for the UI strings for the web-based application from the application server.

In other implementations, obtaining the translated UI strings further includes: transmitting the unique identifiers for the UI strings and the natural language to a translation server associated with a translation datastore, the unique identifiers causing the translation server to retrieve the translated UI strings from the translation datastore using the unique identifiers, and receiving the translated UI strings from the translation server.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of a computing network including example servers according to some implementations of the present disclosure;

FIG. 2 is a functional block diagram of one of the example servers of FIG. 1;

FIG. 3 is a workflow diagram for interaction between the example servers of FIG. 1, a translation datastore, and computing devices associated with users; and

FIG. 4 is a flow diagram of an example technique of translating a user interface of a web-based application according to some implementations of the present disclosure.

### DETAILED DESCRIPTION

The software developer of a web-based application may develop different versions of the web-based application for every possible natural language. This would be very time consuming and would require substantial storage for all of the different versions of the web-based application. Alternatively, run-time translation of the web-based application can be performed. For example, a server could use a translation lookup service during execution of the web-based application. This solution, however, requires extra effort for the software developer to implement, and may require different solutions for different technologies. Another example would be to utilize a proxy server to modify hypertext markup language (HTML) responses to a client with translations. The user interface (UI) of web-based applications, however, is often generated dynamically as opposed to static HTML pages. In addition, not all content of the HTML response should be translated.

Accordingly, techniques for translating UIs of web-based applications are presented. These techniques can provide for run-time translation of UI strings of web-based applications. These techniques can also provide for decreased product development costs by eliminating the need to translate UI strings of web-based applications into a plurality of different languages at a software code level. The term “web-based application” refers to software, e.g., Java, executing in a web browser on a client computing device. The term “user interface” refers to an interactive area of the web-based application where text is displayed and/or input is received. The term “UI string” refers to a text string displayed in the UI of the web-based application.

The techniques can include utilizing a first server to determine a natural language associated with a request for a web-based application and obtaining unique identifiers for the UI strings associated with the web-based application from a corresponding second server. The first server can then transmit the unique identifiers and the natural language to a third server, which can use this information to obtain and return translated UI strings from a local or remote translation datastore. The first server can then return the translated UI strings to the client computing device, which can utilize the translated UI strings while executing the web-based application. In some cases, the first server could also return the web-based application to the client computing device, or, alternatively, the web-based application could be obtained by the client computing device from another source.

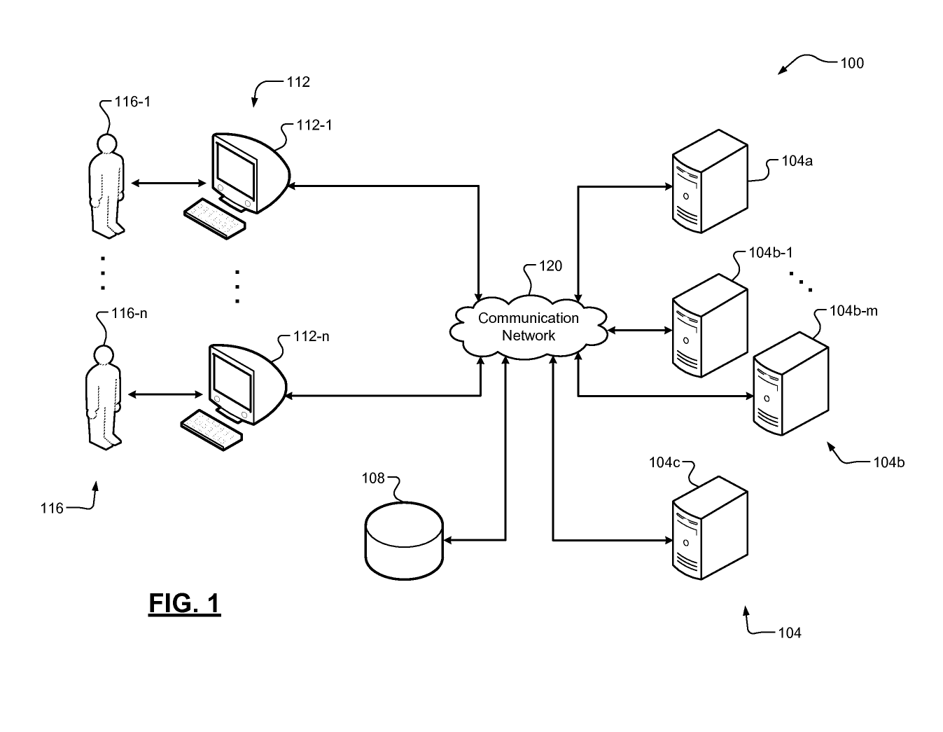

Referring now to FIG. 1, a diagram of a computer network 100 is illustrated. The computer network 100 can include example servers 104a, 104b, and 104c (collectively “servers 104”) according to some implementations of the present disclosure. Each server 104 can be any suitable computing device having one or more processors. While three servers 104 are illustrated, it should be appreciated that other numbers of servers (one, two, four, etc.) can be configured to collectively perform the techniques of the present disclosure.

The first server 104a can also be referred to as a request server 104a. In some implementations, the request server 104 can be a reverse proxy server. The second server 104b can also be referred to as an application server 104b. In some implementations, the second server 104b can be a cracked product server. In some implementations, the computing network 100 can include two or more application servers 104b-1 . . . 104b-m (m>1, collectively “application servers 104b”). The third server 104c can also be referred to as a translation server 104c. In some implementations, the translation server 104 can be a translation application program interface (API) server. A translation datastore 108 can be associated with the translation server 104c. The translation datastore 108 can be located either locally (at the translation server 104c) or remotely from the translation server 104c.

Computing devices 112-1 . . . 112-n (n≧1, collectively “computing devices 112”) can be associated with users 116-1 . . . 116-n (collectively “users 116”). Examples of the computing devices 112 include desktop computers, laptop computers, tablet computers, and mobile phones. Each computing device 112 can be configured to communicate with the request server 104a via a communication network 120. The communication network 120 can include a local area network (LAN), a wide area network (WAN), e.g., the Internet, or a combination thereof.

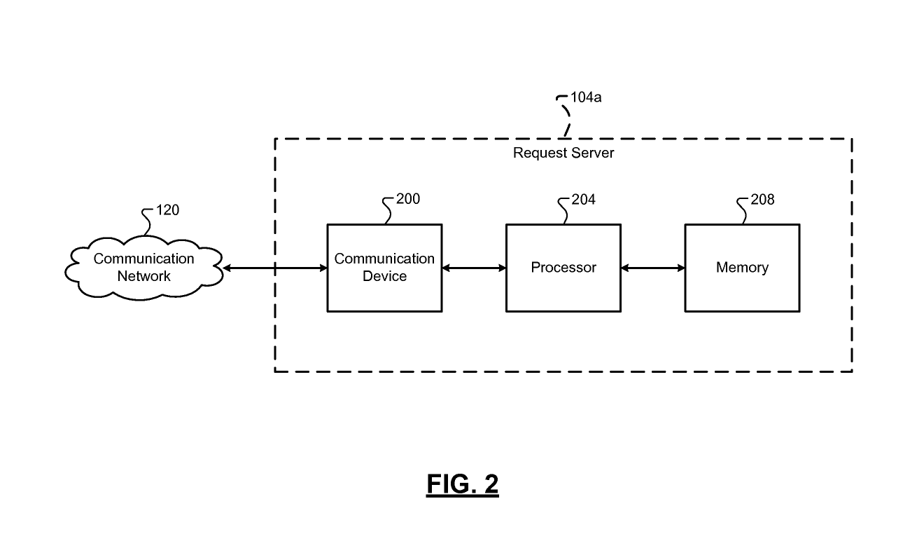

Referring now to FIG. 2, a functional block diagram of the request server 104a is illustrated. The request server 104a can include a communication device 200, a processor 204, and a memory 208. While FIG. 2 illustrates an example configuration for the request server 104a, and it should be appreciated the other servers 104b and 104c may have the same or similar configuration. The communication device 200 can include any suitable components, e.g., a transceiver, configured for communication via the communication network 120. Specifically, the communication device 200 can be configured for communication between the request server 104a and other devices, such as the other servers 104b and 104c, the translation datastore 108, and and/or the computing devices 112, via the communication network 120.

The processor 204 can control operation of the request server 104a. This can include performing functions including, but not limited to, loading/executing an operating system of the request server 104a, controlling communication by the request server 104a (via the communication device 200) via the communication network 120, and controlling read/write operations at the memory 208. The memory 208 can be any suitable storage medium (flash, hard disk, etc.) configured to store information at the request server 104a. It should be appreciated that the term “processor” as used herein can refer to both a single processor and two or more processors operating in a parallel or distributed architecture. The processor 204 can also be configured to execute at least a portion of the techniques of the present disclosure, which is described in greater detail below.

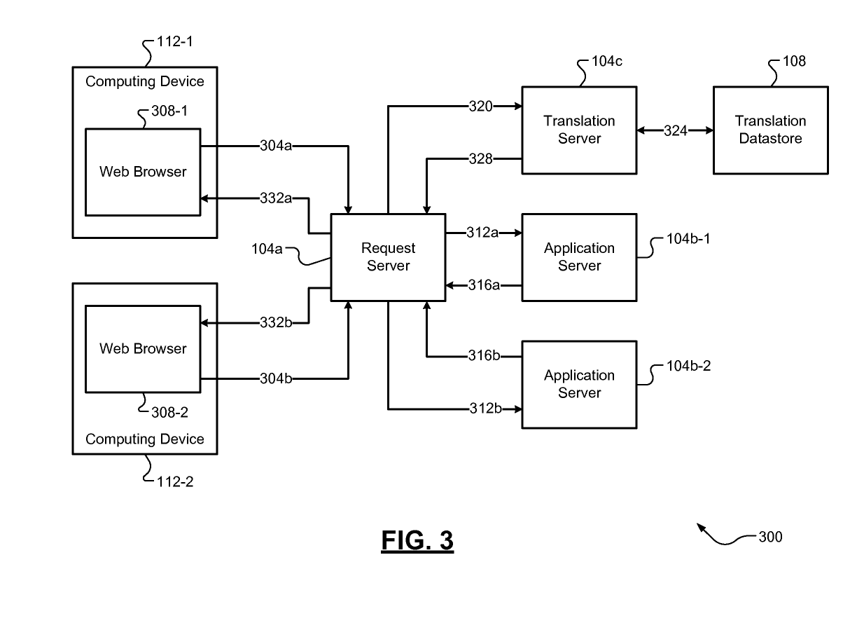

Referring now to FIG. 3, a workflow diagram 300 for interaction between the servers 104, the translation datastore 108, and the computing devices 112 is illustrated.

The request server 104a can initially receive a request 304 for a web-based application from one of the computing devices 112. The request 304 can be generated and transmitted to the request server 104a by web browser software 308 executing on one of the computing devices 112. For example, the request 304 may be generated in response to loading a web page associated with the web-based application. The request server 104a can determine a natural language associated with the request 304. In one implementation, the request is an HTML request that includes information, e.g., metadata, indicative of the natural language associated with the request 304. The natural language associated with the request 304 can also be determined in other manners, such as by retrieving a preferred language of the user associated with the request 304.

In the illustrated example, two requests 304a and 304b associated with different natural languages are illustrated. Request 304a is associated with a first web-based application (prod1) and French (fr), and is generated and transmitted to the request server 104a by web browser software 308a executing at computing device 112-1. For example, request 304a may be an HTML request indicative of French (prod1.com.fr). Request 304b is associated with a second web-based application (prod2) and German (de), and is generated and transmitted to the request server 104a by web browser 308b executing at computing device 112-2. For example, request 304b may be an HTML request indicative of German (prod2.com.de). These languages and HTML requests are merely for exemplary purposes and it should be appreciated that other languages and requests can be utilized.

The request server 104a can obtain UI strings for the web-based application indicated by the request 304. This can include transmitting information identifying the web-based application 312 indicated by the request 304 to its corresponding application server 104b. For example, the identity of the web-based application may be a unique identifier or other identification information. In some cases, the request server 104a can merely forward the request 304 to its corresponding application server 104b. In response, the application server 104b can transmit the unique identifiers 316 for the UI strings for the web-based application back to the request server 104a. As illustrated, the request server 104a transmits information identifying the first web-based application 312a indicated by request 304a to and receives unique identifiers 316a for UI strings for the first web-based application from its application server 104b-1. The request server 104a also transmits information identifying the second web-based application 312b indicated by request 304b to and receives unique identifiers 316b for UI strings for the second web-based application from its application server 104b-2.

The request server 104a can obtain translations of the UI strings from the translation server 104c, which utilizes the translation datastore 108. This can include transmitting the natural language and the unique identifiers 316 (collectively 320) to the translation server 104c. In response, the translation server 104c can then communicate with the translation datastore 108 by using the unique identifiers 316 to obtain translated UI strings in the natural language at 324. For example, the translation server 104c may search the translation datastore 108 to retrieve translated UI strings. The translation server 104c can then transmit the translated UI strings back to the request server 104a at 328. As illustrated, the request server 104a transmits French and unique identifiers 316a (collectively 320a) to the translation server 104c, which returns French-translated UI strings 328a. The request server 104a also transmits German and unique identifiers 316b (collectively 320b) to the translation server 104c, which returns German-translated UI strings 328b.

While a single translation datastore 108 is illustrated, it should be appreciated that different translation datastores could be implemented for different natural languages. The request server 104a can then transmit the translated UI strings 328 back to the web browser software. In one implementation, the request server 104a can transmit an HTML response, e.g., in response to the initial HTML request, that includes the translated UI strings 328. Receiving the translated UI strings 328 can cause the web browser software 308 to execute the web-based application using the translated UI strings 328. As illustrated, the request server 104a transmits the French-translated UI strings 328a to web browser software 308a executing at computing device 112-1 at 332a. The request server 104a also transmits the German-translated UI strings 328b to web browser software 308b executing at computing device 112-2 at 332b.

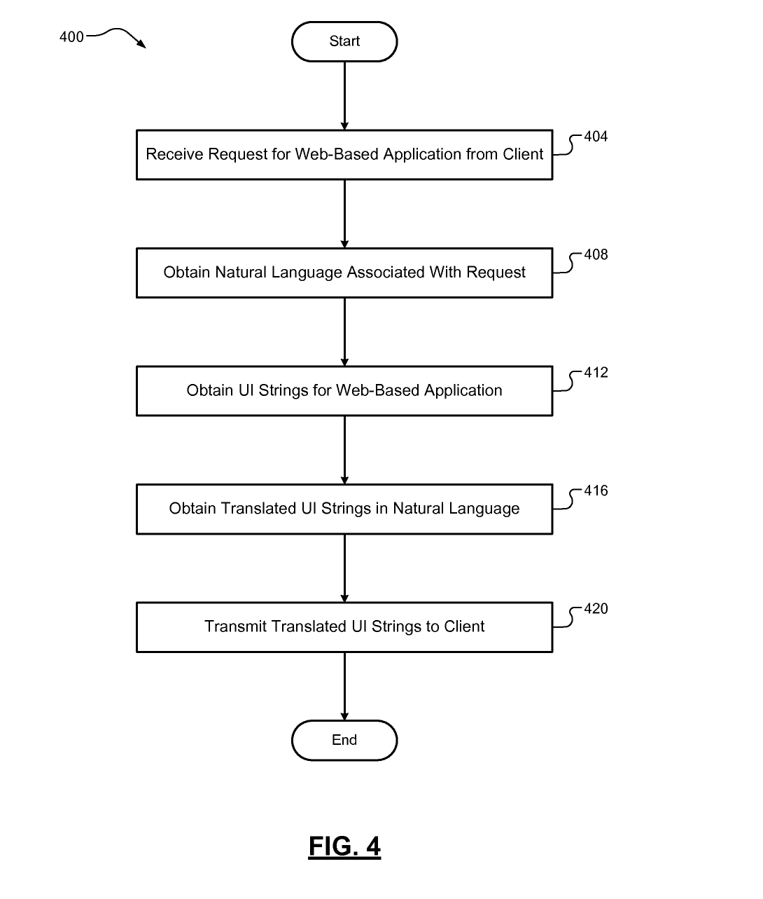

Referring now to FIG. 4, a flow diagram of an example technique 400 for translating a UI of a web-based application is illustrated.

At 404, the request server 104a can receive a request for a web-based application from one of the computing devices 112 (“hereinafter “the computing device 112”). At 408, the request server 104a can obtain a natural language associated with the request. In one implementation, the request is an HTML request and the natural language is retrieved from the HTML request. In another implementation, the natural language is determined from a preferred natural language of one of the users 116 associated with the computing device 112. At 412, the request server 104a can determine UI strings for the web-based application. In one implementation, unique identifiers for the UI strings are obtained from one of the application servers 104b associated with the web-based application.

At 416, the request server 104a can obtain translations of the UI strings in the natural language to obtain translated UI strings. In one implementation, the translated UI strings are obtained from the translation datastore 108 by the translation server 104c using the unique identifiers and the natural language in response to a request and returned to the request server 104a. At 420, the request server 104a can transmit the translated UI strings to the computing device 112. The translated UI strings can cause the computing device 112 to execute the web-based application using the translated UI strings. In one implementation, the request is an HTML request, the request server 104 transmits an HTML response to the computing device 112 in response to the HTML request, and the HTML response includes the translated UI strings. The technique 400 can then end or return to 404 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a request server having one or more processors, a hypertext markup language (HTML) request for a web-based application from a computing device;
obtaining, at the request server, a natural language from the HTML request;
transmitting, from the request server, the HTML request to an application server associated with the web-based application, the HTML request causing the application server to obtain unique identifiers for user interface (UI) strings of the web-based application;
receiving, at the request server, the unique identifiers for the UI strings from the application server;
transmitting, from the request server, the unique identifiers for the UI strings to a translation server associated with a translation datastore, the unique identifiers causing the translation server to retrieve translations of the UI strings in the natural language from the translation datastore using the unique identifiers to obtain translated UI strings;
receiving, at the request server, the translated UI strings from the translation server; and
transmitting, from the request server, an HTML response including the translated UI strings to the computing device, the translated UI strings causing the computing device to execute the web-based application using the translated UI strings.

2. A computer-implemented method, comprising:
receiving, at a request server having one or more processors, a request for a web-based application from a computing device;
obtaining, at the request server, a natural language associated with the request;
determining, at the request server, user interface (UI) strings for the web-based application;
obtaining, at the request server, translations of the UI strings in the natural language to obtain translated UI strings; and
transmitting, by the request server, the translated UI strings to the computing device, wherein the translated UI strings cause the computing device to execute the web-based application using the translated UI strings.

3. The computer-implemented method of claim 2, wherein determining the UI strings for the web-based application further includes:
transmitting, from the request server, the request for the web-based application to an application server associated with the web-based application; and
receiving, at the request server, unique identifiers for the UI strings for the web-based application from the application server.

4. The computer-implemented method of claim 3, wherein obtaining the translated UI strings further includes:
transmitting, from the request server, the unique identifiers for the UI strings and the natural language to a translation server associated with a translation datastore; and
receiving, at the request server, the translated UI strings from the translation server.

5. The computer-implemented method of claim 4, wherein transmitting the unique identifiers for the UI strings and the natural language to the translation server causes the translation server to retrieve the translated UI strings from the translation datastore using the unique identifiers.

6. The computer-implemented method of claim 2, wherein the request for the web-based application is a hypertext markup language (HTML) request.

7. The computer-implemented method of claim 6, wherein the natural language is obtained from the HTML request.

8. The computer-implemented method of claim 6, wherein transmitting the translated UI strings to the computing device includes transmitting, from the request server, an HTML response including the translated UI strings to the computing device.

9. The computer-implemented method of claim 2, wherein obtaining the natural language associated with the request further includes determining, at the request server, a preferred natural language of a user associated with the computing device to obtain the natural language.

10. A request server having one or more processors configured to execute operations comprising:
receiving a request for a web-based application from a computing device;
obtaining a natural language associated with the request;
determining user interface (UI) strings for the web-based application;
obtaining translations of the UI strings in the natural language to obtain translated UI strings; and
transmitting the translated UI strings to the computing device, wherein the translated UI strings cause the computing device to execute the web-based application using the translated UI strings.

11. The request server of claim 10, wherein determining the UI strings for the web-based application further includes:
transmitting the request for the web-based application to an application server associated with the web-based application; and
receiving unique identifiers for the UI strings for the web-based application from the application server.

12. The request server of claim 11, wherein obtaining the translated UI strings further includes:
transmitting the unique identifiers for the UI strings and the natural language to a translation server associated with a translation datastore; and
receiving the translated UI strings from the translation server.

13. The request server of claim 12, wherein transmitting the unique identifiers for the UI strings and the natural language to the translation server causes the translation server to retrieve the translated UI strings from the translation datastore using the unique identifiers.

14. The request server of claim 10, wherein the request for the web-based application is a hypertext markup language (HTML) request.

15. The request server of claim 14, wherein operations further comprise obtaining the natural language from the HTML request.

16. The request server of claim 14, wherein transmitting the translated UI strings to the computing device includes transmitting an HTML response including the translated UI strings to the computing device.

17. The request server of claim 10, wherein obtaining the natural language associated with the request further includes determining a preferred natural language of a user associated with the computing device to obtain the natural language.

18. A non-transitory computer-readable medium having instructions stored thereon that, when executed by one or more processors of a request server, cause the request server to perform operations comprising:
receiving a request for a web-based application from a computing device;
obtaining a natural language associated with the request;
determining user interface (UI) strings for the web-based application;
obtaining translations of the UI strings in the natural language to obtain translated UI strings; and
transmitting the translated UI strings to the computing device, wherein the translated UI strings cause the computing device to execute the web-based application using the translated UI strings.

19. The computer-readable medium of claim 18, wherein determining the UI strings for the web-based application further includes:
transmitting the request for the web-based application to an application server associated with the web-based application; and
receiving unique identifiers for the UI strings for the web-based application from the application server.

20. The computer-readable medium of claim 19, wherein obtaining the translated UI strings further includes:
transmitting the unique identifiers for the UI strings and the natural language to a translation server associated with a translation datastore, the unique identifiers causing the translation server to retrieve the translated UI strings from the translation datastore using the unique identifiers; and
receiving the translated UI strings from the translation server.
